(19) United States
(12) Patent Application Publication
(10) Pub. No.: US 2015/0324702 A1
(43) Pub. Date: Nov. 12, 2015

(54) PREDICTIVE PATTERN PROFILE PROCESS

(71) Applicant: Wal-Mart Stores, Inc., Bentonville, AR (US)

(72) Inventors: Donald High, Noel, MO (US); Michael Atchley, Springdale, AR (US); Jennifer Stegemoller, Pea Ridge, AR (US)

(21) Appl. No.: 14/707,624

(22) Filed: May 8, 2015

Related U.S. Application Data
(60) Provisional application No. 61/991,143, filed on May 9, 2014.

(51) Int. Cl. G06N 5/04

(52) U.S. Cl. CPC G06N 5/047

(57) ABSTRACT

A system and method for providing a prediction is disclosed. A series of historical data or profiles are collected and stored on a database. Using software to provide a first set of predictive patterns from the historical profiles and a second set of predictive patters from the first set of predictive patterns from which the prediction for a particular subject such as sales can be provided.

### RELATED APPLICATION

This application claims priority to U.S. Provisional Patent Application No. 61/991,143, entitled “Predictive Pattern Profile Process”, filed May 9, 2014. The contents of the above-referenced application are herein incorporated by reference in their entirety.

### FIELD OF THE INVENTION

The present invention relates generally to predictive pattern profile. More particularly, the present invention relates to predictive pattern profiles that are more accurate and takes less storage space.

### BACKGROUND OF THE INVENTION

Predictive Pattern Profile is the process of breaking down forecast estimate into any dimensional pattern. The dimensional pattern could be by date, hour, item, location, department, store, division, and the like. Forecasting allows operation management to match supply with potential customer demands. Forecast modeling has been used in accounting to provide cash management, finance to predict equipment replacement needs, and in operations to predict work assignments and workloads.

Forecasting is very important to supply chains and distribution in order to prevent shortages or excesses, which can cause miss deliveries, poor customer service, and work disruptions. Accordingly, it is desirable to provide accurate and timely predictive pattern profiles so that operations management can properly allocate the resources to meet any potential spike in demands or adjusts to decrease in demands based on certain factors such as seasons or other market forces.

### SUMMARY OF THE INVENTION

The foregoing needs are met, to a great extent, by the present invention, wherein in one aspect an apparatus is provided that in some embodiments includes a non-transient computer readable medium containing program instructions for causing a computer to perform the method of collecting a first historical profile for a desired subject, creating a forecast for the desired subject based on the first historical profile, creating a first set of predictive patterns based on the created forecast, discarding the first historical profile once the first set of predictive patterns for the desired subject are created, receiving a request for a prediction of the desired subject, and creating a second set of predictive patterns for the desired subject based on the first set of predictive patterns to create the prediction.

In accordance with another embodiment of the present invention, a method of forecasting of a desired subject is provided and includes the steps of collecting a first historical profile for the desired subject from a database stored on a computing device, creating, with a processor of the computing device, a forecast for the desired subject based on the first historical profile, creating, with the processor of the computing device, a first set of predictive patterns based on the created forecast, discarding the first historical profile from the database once the first set of predictive patterns for the desired subject are created, receiving a request for a prediction of the desired subject, and creating, with the processor of the computing device, a second set of predictive patterns for the desired subject based on the first set of predictive patterns to create the prediction and an updated first historical profile.

In accordance with another embodiment of the present invention, a computing device that provides a prediction that includes a processor in communication with a memory, a database having a first historical profile for a desired subject and being stored on the memory, wherein the processor performs the following steps of creating a forecast for the desired subject based on the first historical profile, creating a first set of predictive patterns based on the created forecast, discarding the first historical profile from the database once the first set of predictive patterns for the desired subject are created, receiving a request for a prediction of the desired subject, and creating, with the processor of the computing device, a second set of predictive patterns for the desired subject based on the first set of predictive patterns to create the prediction and an updated first historical profile.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a forecasting system according to an embodiment of the invention.

FIG. 2 illustrates an exemplary percentage data hourly profile according to embodiment of the invention.

FIG. 3 illustrates a method that provides predictive patterns according to an embodiment of the invention.

### DETAILED DESCRIPTION

The invention will now be described with reference to the drawing figures, in which like reference numerals refer to like parts throughout. An embodiment in accordance with the present invention provides a system that can dynamically generate predictive patterns for variety of uses such as predicting sales, cash flow, potential customer claims, fees associated with third-party services, warranty, returns, energy, supplies, etc.

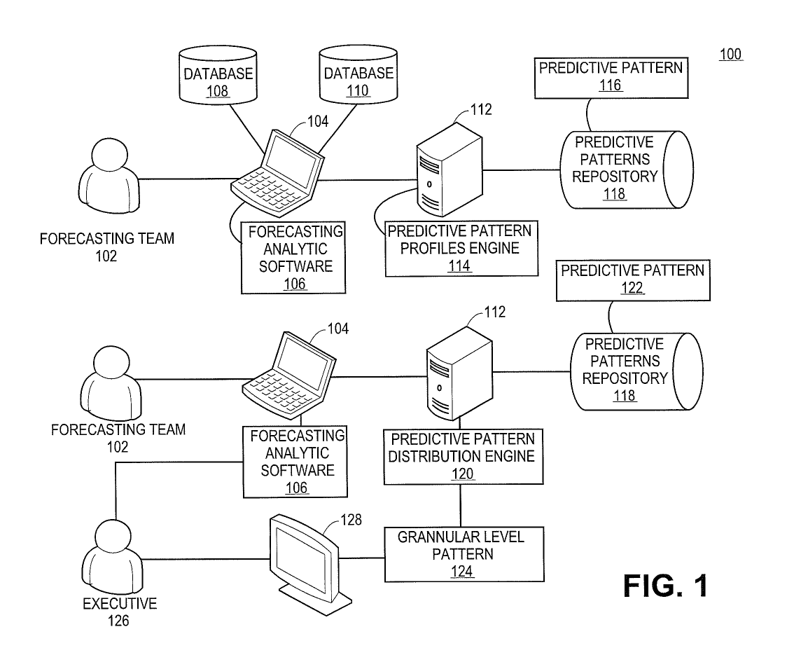

An embodiment of a forecasting system 100 is illustrated in FIG. 1. Forecasting team 102 can include one person or a group of persons that specializes in forecasting various subjects, such as sales, inventory, behavior, weather, stocks, purchases, deliveries, elections, spread of diseases and other subjects. A computing device 104, such as a computer, notebook or tablet can be used to access a remote computer or server 112. Alternatively, forecasting team 102 can directly access server 112 with a user input that is directly or indirectly connected to the server 112. Computing device 104 includes information that has been transferred from the various databases 108, 110. Alternatively, the databases 108, 110 are connected to server 112. The information from databases 108, 110 can be accessed remotely via a wired or wireless connection or the databases can be stored on computing device 104 and/or server 112.

The databases 108, 110 may contain data such as sales, cash flow, customer claims, fees associated with third-party services, warranty, returns, energy usage, supplies, tender types, cash on hand, shrink (difference between actual physical inventory and computer inventory), computer usage, etc. By mining this data, operations manager can make better decisions on a variety of subjects for the company. The data can range from previously collected data (historical) to currently collected data or real time data.

As stores may accept different types of tender, including credit cards, debit cards, checks, cash, coupons, gift cards, food stamps, employee pay cards, electronic cash (e.g. Bit coin, PayPal) and the like. By having accurate tender type forecast information, the company can better predict the fees associated with various tender types, how well the different tender types are performing, and have only the necessary amount of cash on hand for a given time period (week, day, hour, etc.). Each tender type could be assigned a certain percent and categorized by day, by site, or by hour that could then be used to calculate or create the forecast at any level within the company, such as store, region, division, or even total company. Further, depending on when the funds from the various tender are predicted to be received, the company can decide when to invest the funds or when pay down debt.

Often times, a store is charged for credit card processing fees or debit processing fees based on the number or amount of transactions that were processed during a certain time period, such as daily, weekly, monthly or yearly. By predicting the amount including volume of transactions for a given period, the company can potentially negotiate better rates on the fees based on either total amounts or total volume of various transactions.

The store change fund is the amount of cash that a store needs to have on hand to perform their business for a given day. Too much cash in the store means the cash is not being used to provide the most benefit to the company since it could be used to invest or pay down debt. Too little cash means the store cannot perform their business because they don't have the funds available for payroll, check cashing, petty cash, or providing cash back on other transactions to their customers. The store's change fund varies by day and by denomination needed in the store. Each cash register requires a certain amount of cash of specific denominations to be able to provide change and cash back to customers. Each denomination could be assigned a percentage of the total number of transactions that are required for that particular denomination to complete the transaction by register, by store, or by hour.

Shrink is the difference between the physical inventory on hand and the merchandise that is reported as available in the system. This may result from theft, damaged goods, misplacement, or store use of merchandise. Each store needs a forecast amount for shrink for certain periods of time, such as a month, quarter, season, or year. Each product could be assigned a percentage by store or by day that would allow for better forecasting of shrink.

Customer claims are filed when a customer has been injured within the premises of a store, such as slipping or provided incorrect medication. Each type of claims can be assigned a percentage by store or by department that could be used to predict customer claims. This allows for proper insurance coverage to be purchased based on the forecast of claims for the store.

Mainframe used is measured in MIPS (Millions of Instructions per Second), which has costs associated with it. MIPS can be purchased a year or more in advance based on a 4 hour average of peak usage. New projects or upgrades to computer systems that will consume MIPS are estimated and added to the current usage and used to calculate the amount of MIPS that needs to be purchased. If MIPS usage was assigned a percentage for each hour of the year, forecasts could be generated that would show the current peaks and where teams could apply efforts to reduce MIPS usage and thus, decrease the amount of MIPS that needs to be purchased.

The data from databases 108, 110 can be fed into forecasting analytic software 106, which converts the data to forecast results by computing device 104. The forecasting analytic software 106 can be stored on a memory of the computing device or remotely. Then the forecast results can be fed into a predictive pattern profiles engine 114 that can use various software modules to create pattern profiles, such as a first set of predictive patterns 116. Steps used to create the first set of predictive patterns 116 can include determining the purpose of the forecast, defining a time period, using the appropriate data or data points, using the appropriate and relevant forecasting techniques, creating the patterns, monitoring the actual patterns for accuracy, and adjusting accordingly.

Forecasting can include qualitative and/or quantitative data. Qualitative data allows for human factors, such as hunches, and feelings while quantitative data is objective or hard data. Other techniques that can be used with historical data include linear regression analysis and various averaging techniques such as moving average, weighted moving average and exponential smoothing. The averaging techniques allow for smoothing of peaks and valleys that occur in the data and tend to remove random variations that occur. Moving average uses a number of recent actual values, and can be updated as new values or data points become available. Weighted moving averages are similar to moving averages but assign more weight to the most recent values in a series. Exponential smoothing uses previous forecasts plus a percentage of the forecast error.

Still other techniques that could be used to forecast include trend forecasting using a trend equation (linear trend equation) and/or trend adjusted exponential smoothing or tied to recurring events such as seasonal variations and cycles. The examples of techniques described herein are not meant to be limiting and the techniques can be used by itself or in combination with each other. These examples of forecasting techniques can be stored on an internal memory of computing device 104 or server 112, or in an external memory (attached or remote).

Once the first set of predictive patterns 116 are generated, they can be stored on a predictive patterns repository 118 on server 112. Like the forecasting techniques, the predictive patterns repository 118 can be stored on an internal memory of the server 112, computing device 104 or in an external memory (attached or remote).

The first set of predictive patterns 116 can include dimensional pattern such as date, hour, item, fine line, department, store, and division. Thus, each day of the week, each hour of the day can include a profile or pattern of sales, visits, scans, number of cashiers, and other activities. The first set of predictive patterns 116 can be captured to any granular level desired by the user and can represent the percentage of the amount for that time period or dimension. The first set of predictive patterns 116 is not limited to time and date but may be built based upon any dimensions such as who, what, where, when, how and the like including vendors, items or can even be based on hierarchy. The first set of predictive patterns 116 is stored and reused as needed and can be stored in readily identifiable manner.

In one embodiment, the data stored in the database 108, 110 is continuously and dynamically updated with the requisite data points. However, once the first set of predictive patterns 116 is generated, the data that was used to create the first set of predictive patterns 116 may be discarded or deleted. This allows for even more data to be used to create the first set of predictive patterns 116 but also decrease the amount of storage needed for the database 108, 110 as vast amounts of data can be needed to create the first set of predictive patterns 116. Further, as new patterns are generated they will dynamically replace old ones thereby improving the forecasting.

In other embodiments, the first set of predictive patterns 116 may be created if they are 5% different from each other. Additionally, if two or more patterns are within 95% of each other, then one would be discarded. That is, if two patterns are 95% similar to each other in data, then data from the first pattern will be assimilated into the second pattern and the first pattern is deleted. A reference can be made that the information of the first pattern is now in the second pattern. Further, it may not be necessary to create all possible patterns but create patterns when a new pattern would be more than statistically 5% different from an existing pattern. These embodiments can save storage space and costs as every pattern does not have to be generated.

Once the first set of predictive patterns 116 has been created and stored, additional manipulation of the forecast can occur. At this point, the previous data that was used to make the first set of predictive patterns 116 can be deleted to save storage space. The first set of predictive patterns 116 can be dynamically updated as additional data becomes available and stored in databases 108, 110. The forecasting team 102 can at this point create additional patterns or a second set of predictive patterns 122 based on the first set of predictive patterns 116. The second set of predictive patterns 116 can be generated and stored on predictive patterns repository 118 or can be generated when requested. The creation of the first set of predictive patterns 116 required heavy processing power and memory, potentially using multiple servers and significant investments of time from hours to days to weeks depending on the number of data points utilized.

The creation of the second set of predictive patterns 122 should take considerably less time and processing power as the data points (the first set of patterns) should be significantly less. The second set of predictive patterns 122 can be generated using the same or similar forecasting techniques that generated the first set of predictive patterns 116. That is, the first set of predictive patterns 116 are fed into the various forecasting techniques to generate a higher level of forecast results, which is then fed into the predictive pattern distribution engine 120 to generate the second set of predictive patterns 122. The second set of predictive patterns 122 can be stored in the predictive patterns repository 118 for later retrieval. It should be noted that the forecasting technique(s) don't have to be the same ones utilized to create the first set of predictive patterns 116 in order to create the second set of predictive patterns 122. The creation of the second set of predictive patterns 122 can be done on the fly or as requested. Additionally, the second set of predictive patterns 122 can be generated using the predictive pattern profiles engine 114.

Additionally or alternatively, the second set of predictive patterns 122 can be broken down to the granular level patterns 124 using a predictive pattern distribution engine 120 and stored in the predictive patterns repository 118. The granular level patterns 124 can include information about who purchased (male, female, parent, etc.), what item (candy, paper towels, etc.), where (store, division, region, etc.), when (week, day, hour, minute, etc.), how (cash, credit, check, etc.) and the like.

The granular level patterns 124 and any of the first and second predictive patterns 116, 122 can be positioned in the predictive patters repository 118 using various positioning and/or hierarchy schemes depending on the desired information. The granular level patterns 124 can be stored hierarchically, for example, going from top to bottom, by country, by region, by store, by department, by product, by product code, etc. This allows for the desired predictive pattern to be easily identified, retrieved and manipulated or easily drilled down as desired. The granular level patterns 124 may be positioned horizontally for additional manipulation.

Once the granular level patterns 124 are generated (either previously or upon request), they are available for use to create requested forecasts. At this point, an executive 126 can request a prediction as to the number of Parent's Choice (diapers), a Wal-Mart product that will be sold in the second quarter of 2017 as she is negotiating logistics contracts or suppliers' agreement in order to maintain current pricing levels. The granular level patterns 124 can be used to provide the requested forecast for Parent's Choice. The requested forecast can be viewed on a display 128 by the executive 126 and/or the forecasting team 102. As many granular level patterns 124 or combinations thereof can be generated as requested by the executive 126 or the forecasting team 102. Additionally, the granular level patterns 124 can be generated relatively quickly so that business decisions can be made in a timely manner.

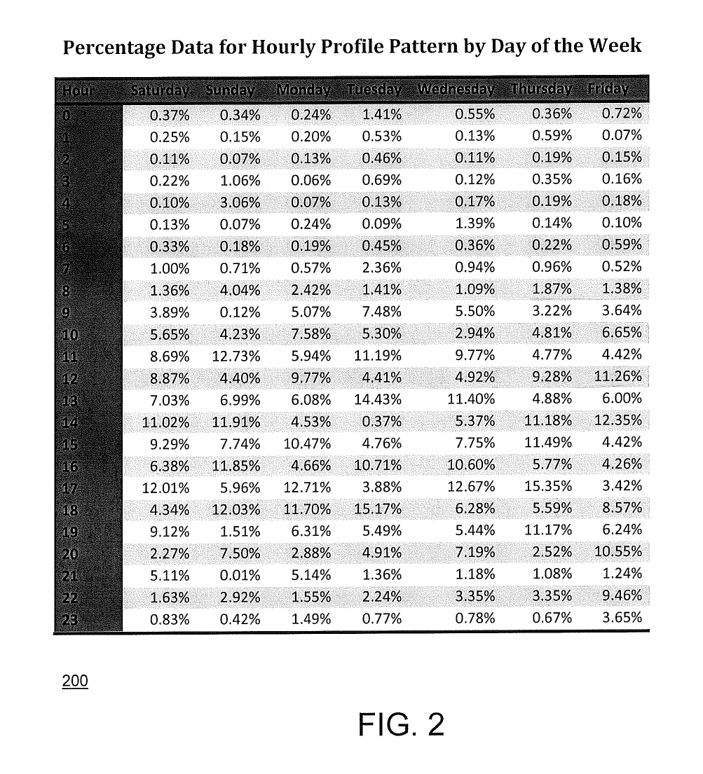

FIG. 2 illustrates a percentage data hourly profile 200 according to embodiment of the invention. Profile 200 illustrates an example of percentage data for hourly profile by day of the week and is also known as historical profile as it includes historical data. Profile 200, for example, can be percentage data for certain type of credit transaction, sales for a particular item, number of people entering the store, the amount of electricity used, the number of bags used, or any other subject matter desired by the user. Profile 200 can also be characterized various ways, such as percentage data related to seasonal, monthly, yearly, holiday, daily, and any other types of profile desired by the user. Profile 200 can be stored in database 108, 110. Thus, profile 200, for example, can include information such as electricity usage for the store or division by each hour, each day, each week, each month, each quarter, each season, each year, and the like. This allows for vast number of data points in order to create accurate predictive patterns 116, 122.

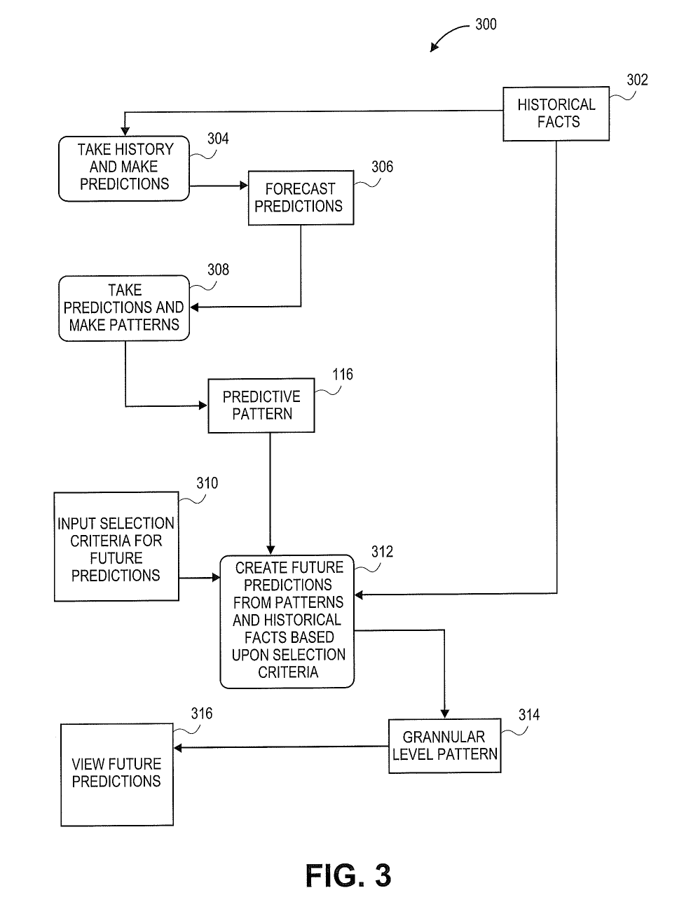

FIG. 3 illustrates a method 300 that provides predictive patterns according to an embodiment of the invention. At step 302, historical facts such as information contained in profile 200 can be fed into step 304 or step 312. There is no limit into the number of profile 200 that can be used. At step 304, as many profile 200 as needed are extracted or collected from database 108, 110 to make forecasts. At step 306, computing device 104 or server 112 and forecasting analytic software 106, for example, can be used to create or calculate forecasts from profile 200. At step 308, forecasts can be sent to server 112 (at computing device 104), which can use predictive pattern profiles engine 114 to create the first set of predictive pattern 116. The first set of predictive patterns 116 can be stored in predictive patterns repository 118. At this point, the profile 200 may be discarded or deleted. At step 310, the forecasting team 102 and/or the executive 126 can input selection criteria for future predictions. Input may be at computing device 104 using a predefined graphical user interface. At step 312, server 112 (or computing device 104) using the predictive pattern distribution engine 120 can create future forecast, such as the second set of predictive patterns 122 from the first set of predictive patterns 116 and/or updated profile 200. The second set of predictive pattern can also include granular level pattern 314, which can then be viewed at step 316 on the display 128.

It should be noted, that the steps described for FIG. 3 do not have to be performed in order and that all the steps have to be performed in order or out of order to achieve the results of the invention. The computing device 104 or server 112 may be a personal computer (PC), a UNIX workstation, a server, a mainframe computer, a personal digital assistant (PDA), smartphone, cellular phone, a tablet computer, a laptop computer, a netbook, a slate computer, or some combination of these. Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein. The computing devices described herein include standard components such as a processor/controller, a memory, a display, input/output devices (keyboard, mouse, etc.), communication bus, connections (USB, Serial, Wireless), software including operating systems and predictive and forecasting techniques and the like, a camera, power supply and the like.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored. The software (for example, predictive pattern profile and distribution engine) described herein may be part of one software module and are not required to be separate.

Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The invention can include the computer-readable medium having stored thereon a data structure including a plurality of fields containing data representing the techniques of the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A non-transient computer readable medium containing program instructions for causing a computer to perform the method of:
collecting a first historical profile for a desired subject;
creating a forecast for the desired subject based on the first historical profile;
creating a first set of predictive patterns based on the created forecast;
discarding the first historical profile once the first set of predictive patterns for the desired subject are created;
receiving a request for a prediction of the desired subject; and
creating a second set of predictive patterns for the desired subject based on the first set of predictive patterns to create the prediction.

2. The non-transient computer readable medium of claim 1, wherein creating the first set of predictive patterns is also based on an updated first historical profile.

3. The non-transient computer readable medium of claim 1 further comprising:
saving the first and second sets of predictive patterns to a predictive patterns repository; and
displaying the requested prediction on a display.

4. The non-transient computer readable medium of claim 1, wherein the prediction desired subject includes sales, cash flow, potential customer claims, fees associated with third-party services, warranty, returns, energy, and supplies.

5. The non-transient computer readable medium of claim 1, wherein the prediction desired subject is categorize by date, hour, item, department, store, or division.

6. The non-transient computer readable medium of claim 1, wherein a second historical profile is within a statistical 5% difference from the first historical profile and the first and second historical profiles are dynamically updatable.

7. The non-transient computer readable medium of claim 1, wherein if the first and second historical profiles are similar within 95%, then information of one of the historical profiles will be assimilated into the other historical profile and then deleted.

8. The non-transient computer readable medium of claim 1, wherein the step of creating g the first set of predictive patterns takes more time than the step of creating the second set of predictive patterns.

9. The non-transient computer readable medium of claim 1, wherein the first and second set of predictive patterns are stored vertically in a memory of a computing device.

10. A method of forecasting of a desired subject, comprising the steps of:
collecting a first historical profile for the desired subject from a database stored on a computing device;
creating, with a processor of the computing device, a forecast for the desired subject based on the first historical profile;
creating, with the processor of the computing device, a first set of predictive patterns based on the created forecast;
discarding the first historical profile from the database once the first set of predictive patterns for the desired subject are created;
receiving a request for a prediction of the desired subject; and
creating, with the processor of the computing device, a second set of predictive patterns for the desired subject based on the first set of predictive patterns to create the prediction and an updated first historical profile.

11. The method of claim 10, wherein the step of creating the first set of predictive patterns is also based on a second historical profile.

12. The method of claim 11, wherein for the first historical profile is a time of sale of an item and the second historical profile is what the item is.

13. The method of claim 10, further comprising the steps of:
saving the first and second sets of predictive patterns to a predictive patterns repository on a memory of the computing device; and
displaying the requested prediction on a display.

14. The method of claim 10, wherein the prediction desired subject includes sales, cash flow, potential customer claims, fees associated with third-party services, warranty, returns, energy, and supplies.

15. The method of claim 10, wherein the prediction desired subject s categorize by date, hour, item, department, store, or division.

16. The method of claim 10, wherein a second profile is within a statistical 5% difference from the first historical profile and the first and second historical profiles are dynamically updatable.

17. The method of claim 10, wherein if the first and second historical profiles are similar within 95%, then information of one of the historical profiles will be assimilated into the other historical profile and then deleted.

18. The method of claim 10, wherein the step of creating the first set of predictive patterns takes more time than the step of creating the second set of predictive patterns.

19. The method of claim 10, wherein the first and second set of predictive patterns are stored vertically in a memory of a computing device.

20. A computing device that provides a prediction, comprising:
a processor in communication with a memory; and
a database having a first historical profile for a desired subject and being stored on the memory, wherein the processor performs the following steps:
creating a forecast for the desired subject based on the first historical profile;
creating a first set of predictive patterns based on the created forecast;
discarding the first historical profile from the database once the first set of predictive patterns for the desired subject are created;
receiving a request for a prediction of the desired subject; and
creating, with the processor of the computing device, a second set of predictive patterns for the desired subject based on the first set of predictive patterns to create the prediction and an updated first historical profile.
